(19) United States
(12) Patent Application Publication
(10) Pub. No.: US 2026/0142211 A1
(43) Pub. Date: May 21, 2026

(54) FLOW BATTERY FLOW FIELD WITH MULTIPLE SERPENTINE CHANNELS

(71) Applicant: RTX CORPORATION, Arlington, VA (US)

(72) Inventors: James D. Saraidaridis, East Hartford, CT (US); Robert Darling, East Hartford, CT (US)

(21) Appl. No.: 18/950,633

(22) Filed: Nov. 18, 2024

(51) Int. Cl. H01M 8/18; H01M 8/0263

(52) U.S. Cl. CPC H01M 8/188; H01M 8/0263

(57) ABSTRACT

A redox flow battery includes at least one flow field including a plurality of serpentine channels to communicate electrolyte. Each of the serpentine channels define an inlet end, an outlet end, and a flow path fluidly connecting the inlet end with the outlet end. The serpentine channels are arranged in a parallel flow configuration.

### BACKGROUND

This disclosure relates to flow batteries for selectively storing and discharging electric energy.

Flow batteries, also known as redox flow batteries or redox flow cells, are designed to convert electrical energy into chemical energy that can be stored and later released when there is demand. As an example, a flow battery may be used with a renewable energy system, such as a wind-powered system, to store energy that exceeds consumer demand and later release that energy when there is greater demand.

A basic flow battery includes a redox flow cell having a negative electrode and a positive electrode separated by an ion-exchange membrane. A negative electrolyte is delivered to the negative electrode and a positive electrolyte is delivered to the positive electrode to drive an electrochemically reversible redox reaction. Upon charging, the electrical energy supplied causes an electrochemical reduction reaction in one electrolyte and an oxidation reaction in the other electrolyte. The ion-exchange membrane prevents the electrolytes from mixing but permits selected ions to pass through to maintain electroneutrality. Upon discharge, the chemical energy contained in the electrolyte is released in the reverse reactions and electrical energy can be drawn from the electrodes.

### SUMMARY

A redox flow battery according to an example of the present disclosure includes at least one flow field including a plurality of serpentine channels to communicate electrolyte. Each of the plurality of serpentine channels define an inlet end, an outlet end, and a flow path fluidly connecting the inlet end with the outlet end. The plurality of serpentine channels are arranged in a parallel flow configuration.

In a further embodiment of any of the foregoing embodiments, each of the plurality of serpentine channels includes an inlet leg, a first turn section, an intermediate leg, a second turn section, and an outlet leg. The inlet leg extends from the inlet end to the first turn section, the intermediate leg extends from the first turn section to the second turn section, and the outlet leg extends from the second turn section to the outlet end.

In a further embodiment of any of the foregoing embodiments, the plurality of serpentine channels are arranged in an un-nested configuration.

In a further embodiment of any of the foregoing embodiments, the plurality of serpentine channels include a first serpentine channel and a second, neighboring serpentine channel. The inlet leg of the first serpentine channel is adjacent to the outlet leg of the second, neighboring serpentine channel. The outlet leg of the second, neighboring serpentine channel is between the inlet leg of the first serpentine channel and the inlet leg of the second, neighboring serpentine channel.

In a further embodiment of any of the foregoing embodiments, the plurality of serpentine channels are arranged in a nested configuration.

In a further embodiment of any of the foregoing embodiments, each of the plurality of serpentine channels is arranged side-by-side such that the inlet leg, intermediate leg, outlet leg, first turn section, and second turn section of a first serpentine channel of the plurality of serpentine channels is arranged adjacent to and aligned with the inlet leg, intermediate leg, outlet leg, first turn section, and second turn section, respectively, of at least one neighboring serpentine channel of the plurality of serpentine channels.

In a further embodiment of any of the foregoing embodiments, each of the inlet leg, intermediate leg, outlet leg, first turn section, and second turn section are straight segments.

A further embodiment of any of the foregoing embodiments includes a common inlet manifold and a common outlet manifold. Each of the inlet ends opens to the common inlet manifold and each of the outlet ends opens to the common outlet manifold.

A further embodiment of any of the foregoing embodiments includes a first liquid-porous electrode, a second liquid-porous electrode spaced apart from the first liquid-porous electrode, and an ion-exchange membrane arranged between the first liquid-porous electrode and the second liquid-porous electrode. The at least one flow field includes first and second flow fields adjacent, respectively, the first liquid-porous electrode and second liquid-porous electrode. A first electrolyte storage vessel is connected in a first circulation loop with the first flow field and a second electrolyte storage vessel is connected in a second circulation loop with the second flow field.

A redox flow battery according to an example of the present disclosure includes at least one flow field including a plurality of serpentine channels to communicate electrolyte. Each of the serpentine channels define an inlet end, an outlet end, and a flow path fluidly connecting the inlet end with the outlet end. The serpentine channels are arranged in a parallel flow configuration, the plurality of serpentine channels arranged in an un-nested configuration.

A further embodiment of any of the foregoing embodiments includes a first circulation loop, a second circulation loop, a first electrolyte storage vessel connected to the first circulation loop, and a second electrolyte storage vessel connected to the second circulation loop. The at least one flow field includes a first flow field and a second flow field, and the first and second circulation loops are operable to fluidly communicate with the first and second flow fields, respectively, and first and second electrolyte storage vessels, respectively. An ion-exchange membrane is arranged between the first and the second flow fields.

In a further embodiment of any of the foregoing embodiments, each of the plurality of serpentine channel includes an inlet leg, a first turn section, an intermediate leg, a second turn section, and an outlet leg. The inlet leg extends from the inlet end to the first turn section, the intermediate leg extends from the first turn section to the second turn section, and the outlet leg extends from the second turn section to the outlet end.

In a further embodiment of any of the foregoing embodiments, the plurality of serpentine channels includes a first serpentine channel and a second, neighboring serpentine channel. The inlet leg of the first serpentine channel is adjacent to the outlet leg of the second, neighboring serpentine channel. The outlet leg of the second, neighboring serpentine channel is between the inlet leg of the first serpentine channel and the inlet leg of the second, neighboring serpentine channel.

In a further embodiment of any of the foregoing embodiments, each of the inlet leg, intermediate leg, outlet leg, first turn section, and second turn section are straight segments.

A redox flow battery according to an example of the present disclosure includes at least one flow field that includes at least one group of serpentine channels to communicate electrolyte. Each of the serpentine channels define an inlet end, an outlet end, and a flow path fluidly connecting the inlet end with the outlet end. The serpentine channels are arranged in a parallel flow configuration and in a nested configuration.

In a further embodiment of any of the foregoing embodiments, each serpentine channel includes an inlet leg, a first turn section, an intermediate leg, a second turn section, and an outlet leg. The inlet leg extends from the inlet end to the first turn section, the intermediate leg extends from the first turn section to the second turn section, and the outlet leg extends from the second turn section to the outlet end.

In a further embodiment of any of the foregoing embodiments, the at least one group of serpentine channels includes a first group of serpentine channels. Each serpentine channel of the first group of serpentine channels is arranged side-by-side, such that the inlet leg, intermediate leg, outlet leg, first turn section, and second turn section of a first serpentine channel of the first group of serpentine channels is arranged adjacent to and aligned with the inlet leg, intermediate leg, outlet leg, first turn section, and second turn section, respectively, of at least one neighboring serpentine channel in the first group of serpentine channels.

In a further embodiment of any of the foregoing embodiments, the at least one group of serpentine channels includes a second group of serpentine channels that neighbors the first group of serpentine channels. The first group of serpentine channels and the second group of serpentine channels are arranged in a repeated, configuration such that the outlet legs of the first group of serpentine channels are positioned adjacent to the inlet legs of the second group of serpentine channels and the inlet legs of the second group of serpentine channels are positioned between the outlet legs of the second group of serpentine channels and the outlet legs of the first group of serpentine channels.

In a further embodiment of any of the foregoing embodiments each of the inlet leg, intermediate leg, outlet leg, first turn section, and second turn section are straight segments.

A further embodiment of any of the foregoing embodiments includes a first circulation loop, a second circulation loop, a first electrolyte storage vessel connected to the first circulation loop, and a second electrolyte storage vessel connected to the second circulation loop. The at least one flow field includes a first flow field and a second flow field. The first and second circulation loops are operable to fluidly communicate with the first and second flow fields, respectively, and the first and second electrolyte storage vessels, respectively. An ion-exchange membrane is arranged between the first and the second flow fields.

### BRIEF DESCRIPTION OF THE DRAWINGS

The various features and advantages of the disclosed examples will become apparent to those skilled in the art from the following detailed description.

In this disclosure, like reference numerals designate like elements where appropriate, and reference numerals with the addition of one-hundred or multiples thereof designate modified elements. The modified elements are understood to incorporate the same benefits and/or features of the corresponding original elements.

The drawings that accompany the detailed description can be briefly described as follows.

FIG. 1 illustrates an example flow battery.

FIG. 2 illustrates flow fields of the example flow battery.

FIG. 3 illustrates a view of the un-nested serpentine channels normal to the plane formed by the channels.

FIG. 4 illustrates a side, cross-sectional view of the un-nested serpentine channels and electrodes of FIG. 3 where inlets and outlets enter/leave the cell.

FIG. 5 illustrates a view of the nested serpentine channels normal to the plane formed by the channels.

FIG. 6 illustrates a side, cross-sectional view of the nested serpentine channels and electrodes of FIG. 5 where inlets and outlets enter/leave the cell.

FIG. 7 illustrates a view of repeated groups of the nested serpentine channels normal to the plane formed by the channels.

### DETAILED DESCRIPTION OF THE PREFERRED EMBODIMENT

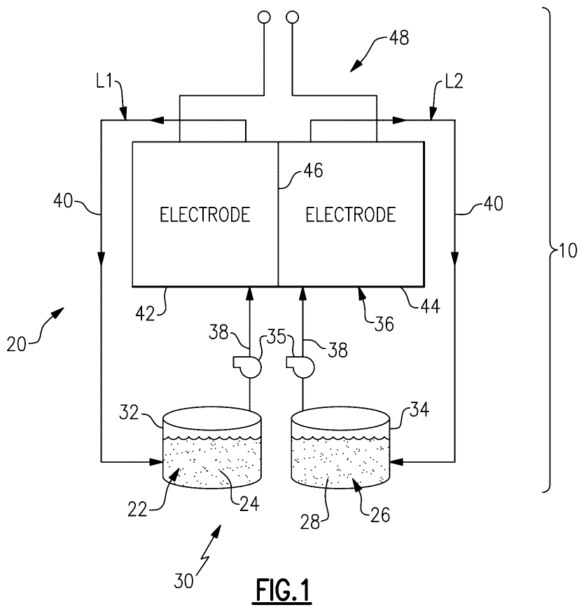

FIG. 1 schematically shows portions of an example system 10 that includes a redox flow battery 20 (“RFB 20”) for selectively storing and discharging electrical energy. As an example, the RFB 20 can be used to convert electrical energy to chemical energy. At a later time, the RFB 20 can be used to convert the chemical energy back into electrical energy that may be provided to an electric grid, for example. The RFB 20 thus provides for electrical energy storage.

The RFB 20 includes a first electrolyte solution 22 that has at least one electrochemically active species 24 that functions in a redox pair with regard to a second electrolyte solution 26 that has at least one electrochemically active species 28. As will be appreciated, the terminology “first” and “second” is to differentiate that there are two distinct electrolytes.

The electrochemically active species 24, 28 include ions that have multiple, reversible oxidation states in a selected base solvent, such as but not limited to, water, acetonitrile, dimethoxyethane, and propylene carbonate. In some examples, the multiple oxidation states are non-zero oxidation states, such as transition metals including but not limited to vanadium, iron, manganese, chromium, zinc, molybdenum, sulfur, cerium, lead, tin, titanium, germanium, and functional combinations thereof. In some cases, the transition metals can be modified by bound chelating agents, including but not limited to ethylendiaminetetraacetic acid (EDTA) or other aminopolycarboxylic acids, acetylacetonates, bipyridyls, and phenanthrenes. In some examples, the multiple oxidation states can include the zero oxidation state if the element is readily soluble in the selected liquid solution in the zero oxidation state. Such elements can include the halogens, such as bromine, chlorine, and combinations thereof. The electrochemically active species 24, 28 could also be organic molecules or macromolecules that contain groups that undergo electrochemically reversible reactions, such as quinones or nitrogen-containing organics, such as quinoxalines or pyrazines. The electrolytes 22, 26 are solutions that include one or more of the electrochemically active species 24, 28. The first electrolyte solution 22 and the second electrolyte solution 26 are contained in a supply/storage system 30 that includes first and second vessels 32, 34.

The electrolyte solutions 22, 26 are circulated by pumps 35 to at least one redox flow cell 36 of the RFB 20 through respective feed lines 38, and are returned from the cell 36 to the vessels 32, 34 via respective return lines 40. As can be appreciated, additional pumps 35 can be used if needed, as well as valves (not shown) at the inlets/outlets of the components of the RFB 20 to control flow. In this example, the feed lines 38 and the return lines 40 connect the vessels 32, 34 in respective circulation loops L1, L2 with first and second electrodes 42, 44. Multiple cells 36 can be provided as a stack within the circulation loops L1, L2.

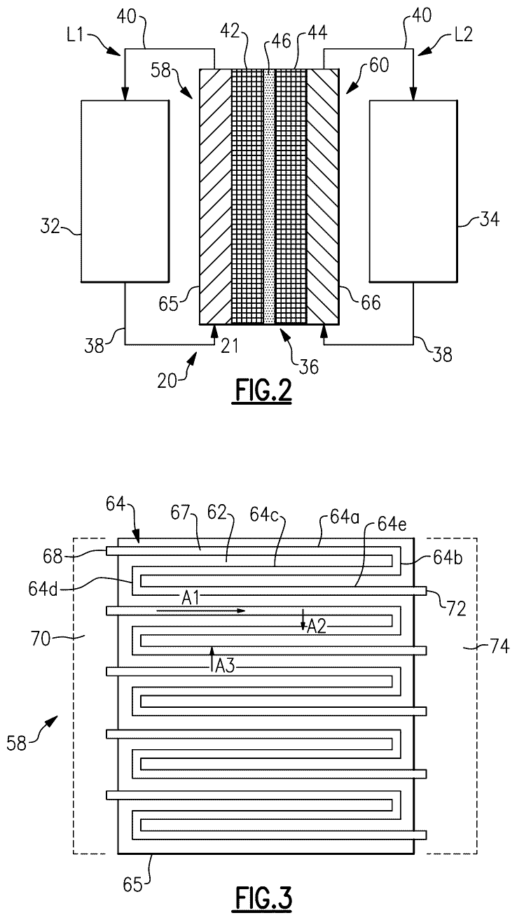

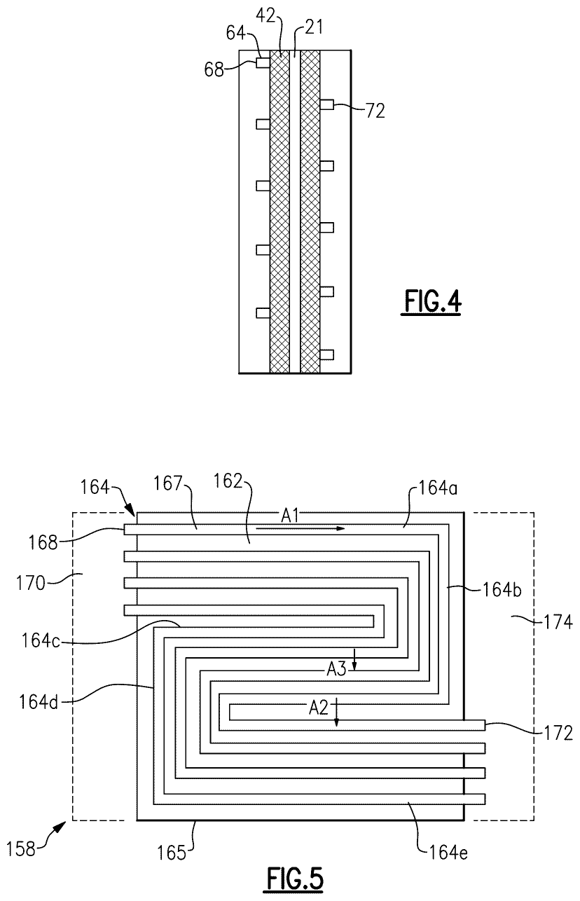

FIG. 2 illustrates portions of the system 10 and additional structure of the cell 36. The cell 36 includes the first electrode 42, the second electrode 44 spaced apart from the first electrode 42, and a barrier layer 46 arranged between the first electrode 42 and the second electrode 44. For example, the electrodes 42, 44 may be porous electrically-conductive structures, such as carbon paper or felt. The electrodes 42, 44 may also contain additional materials 21 which are catalytically-active, for example, a metal or metal oxide. The cell 36 further includes flow fields 58 and 60. The flow fields 58 and 60 include ribs 62, as shown in FIG. 3, that define channels 64 formed in respective flow field plates 65 and 66, such as graphite or metal plates. The electrodes 42 and 44 and the barrier layer 46 are sandwiched between the flow field plates 65, 66 such that the channels 64 open to the electrodes 42, 44 (see FIG. 4).

The barrier layer 46 can be, but is not limited to, an ionic-exchange membrane, a micro-porous polymer membrane, or an electrically insulating microporous matrix of a material, such as silicon carbide (SiC), that prevents the electrolyte solutions 22, 26 from freely and rapidly mixing but permits selected ions to pass through to complete the redox reactions while electrically isolating the electrodes 42, 44. In this regard, the loops L1, L2 are isolated from each other during normal operation, such as charge, discharge and shutdown states.

The electrolyte solutions 22, 26 may be delivered to, and circulate through, the cell or cells 36 during an active charge mode and discharge mode to either convert electrical energy into chemical energy or, in the reverse reaction, convert chemical energy into electrical energy that is discharged. The electrical energy is transmitted to and from the cell or cells 36 through an electric circuit 48 that is electrically coupled with the electrodes 42, 44.

As shown in FIG. 3, the first flow field 58 includes channels 64 for delivering the electrolyte solutions 22 from the storage vessel 32 to the electrode 42. Generally, the following description is discussed with respect to the first flow field 58. However, it is to be understood that the description below for each embodiment applies equally to the second flow field 60, which has an identical configuration with respect to storage vessel 34, electrolyte solution 26, the electrode 44, and other components. In this case, the first flow field 58 is comprised of channels 64 which are defined by ribs 62 on the flow field plate 65. The channels 64 provide passages 67 to facilitate the flow of electrolyte 22. The ribs 62 and channels 64 may vary in width, depth, and/or length in order to manage relative pressure drop in the electrolyte 22 flow through the channels 64. Each of the channels 64 includes an inlet 68 that opens to an inlet manifold 70. The inlet manifold 70 serves as a common upstream source of electrolyte 22 within the flow field 58, and is in fluid communication with the feed line 38 from the storage vessel 32. Further, the channels 64 include an outlet 72 that opens to an outlet manifold 74. The outlet manifold 74 functions as a common downstream sink for electrolyte 22 from the first flow field 58, and is in fluid communication with the return line 40, which feeds back into the storage vessel 32.

Accordingly, the electrolyte 22 flows sequentially from the storage vessel 32, through the feed line 38, into the inlet manifold 70, through the channels 64, and then into the outlet manifold 74. From the outlet manifold 74, the electrolyte 22 is returned to the vessel 32 through the return line 40. Thus, the total electrolyte 22 flow from the inlet manifold 70 is divided between the channels 64, with each channel 64 receiving a portion of the total flow. The electrolyte 22 flows in the individual channels 64 and then recombines in the outlet manifold 74. The division of the electrolyte 22 flow from the inlet manifold 70 into the channels 64, the divided flow through the channels 64, and the recombination of the electrolyte flow in the outlet manifold 74 constitutes a parallel flow configuration.

FIG. 3 is a plan view of the flow field 58, and FIG. 4 is an inlet/outlet edge view through the thickness of the plate 65 of the flow field 58. The channels 64 have a “serpentine” configuration, which means that each channel 64 winds or turns back on itself several times. Each channel 64 includes an inlet leg 64a extending from the inlet 68 to a first turn section 64b. The first turn section 64b extends from the inlet leg 64a to an intermediate leg 64c, and the intermediate leg 64c extends from the first turn section 64b to a second turn section 64d. The second turn section 64d extends from the intermediate leg 64c to an outlet leg 64e, and the outlet leg 64e extends from the second turn section 64d to the outlet 72.

In the example illustrated in FIG. 3, each of the inlet leg 64a, the intermediate leg 64c, and the outlet leg 64e are straight segments. The flow of electrolyte 22 through the inlet leg 64a and outlet leg 64e is generally in the same direction, while the flow of electrolyte 22 through the intermediate leg 64c is in the opposite direction to the flow of electrolyte 22 in the inlet leg 64a and outlet leg 64e. The first and second turn sections 64b and 64d may be straight, curved, or angled segments for redirecting the flow of electrolyte 22. In the example in FIG. 3, the first and second turn sections 64b and 64d extend substantially perpendicularly to the central axis of one or more of the inlet leg 64a, intermediate leg 64c, or outlet leg 64e. Each of the legs 64a, 64c, and 64e and turn sections 64b and 64d are defined by the ribs 62.

In operation, a portion of the electrolyte 22 flows sequentially from the inlet manifold 70, through the inlet leg 64a, the first turn section 64b, the intermediate leg 64c, the second turn section 64d, the outlet leg 64e, and exits to the outlet manifold 74, as indicated by arrow A1 in FIG. 3. Hereafter, arrow A1 represents the flow of electrolyte through the flow passage 67 of the channels 64 for each embodiment.

There is a pressure drop in the electrolyte 22 flow through the serpentine channels 64 between the inlet manifold 70 and outlet manifold 74. For example, friction with the sides of the channels 64 and turns in the direction of the electrolyte 22 flow can cause loss of pressure. For more viscous fluids, internal friction amplifies these effects. Thus, the highest pressure in the channel 64 is at the inlet 68 and the lowest pressure is at the outlet 72. Moreover, there can be a difference in pressure between legs 64a, 64c, 64e and sections 64b, 64d of the same channel 64 and/or neighboring legs 64a, 64c, 64e and sections 64b, 64d of two adjacent channels 64. This difference in pressure can act as a driving force for electrolyte to flow over the ribs 62, from a higher-pressure location to a lower pressure location. For example, the pressure in the inlet leg 64a is higher than the pressure in the intermediate leg 64c of the same channel 64 and a portion of the electrolyte 22 may flow over the top of the rib 62, as indicated by arrow A2 in FIG. 3. Hereafter, arrow A2 represents the flow of electrolyte 22 over ribs 62 adjacent to legs 64a, 64c, 64e of the same channel 64 for each embodiment. As another example, the pressure in the inlet leg 64a of one serpentine channel 64 is higher than the pressure in the outlet leg 64e of the adjacent, neighboring channel 64, causing a portion of the electrolyte 22 to flow over the top of the rib 62, as indicated by arrow A3 in FIG. 3. Hereafter, arrow A3 represents the flow of electrolyte 22 over ribs 62 adjacent to the legs 64a, 64c, 64e of separate channels 64 for each embodiment. The flow of the electrolyte solution 22 over the ribs 62 provides a lower overall pressure drop between the inlet 68 and outlet 72 of the channel 64 than if the flow of electrolyte 22 was entirely through the channels 64.

In the example of FIGS. 3-4, the channels 64 and corresponding flow passages 67 are in an “un-nested” serpentine configuration in which the serpentine channels 64 are positioned alongside each other rather than “fitting” one within another. With the exception of the serpentine channels 64 arranged at the end of the flow plate 65, the inlet leg 64a of a first serpentine channel 64 is positioned adjacent to the outlet leg 64e of a second, neighboring serpentine channel 64, such that only a single rib 62 separates the inlet leg 64a of the first serpentine channel 64 from the outlet leg 64e of the neighboring serpentine channel 64. Furthermore, the outlet leg 64e of the second, neighboring serpentine channel 64 is between the inlet leg 64a of the first serpentine channel 64 and the inlet leg 64a of the second, neighboring serpentine channel 64. Using multiple un-nested serpentine channels 64 facilitates scaling of the flow field 58 to larger or smaller plan forms. This is achieved by maintaining the channel 64 length while adjusting the number of channels 64. Flow fields 58 using multiple un-nested serpentine channels 64 can accomplish similar flow behavior as a single, larger serpentine flow channel 64, but with less pressure drop. This enables use of cells that do not have high-pressure ratings, reduces pumping losses, and allows for scalable plan forms to suit various applications.

The configuration of the channels 64 may be modified in order to further tailor the pressure drop. For example, some channels 64 may be modified to have more or fewer legs 64a, 64c, 64e and turn sections 64b, 64d. As another example, some channels 64 may be modified so that the outlet legs 64e of neighboring channels 64 are adjacent to one another or so that the inlet legs 64a of neighboring channels 64 are adjacent to one another, which may reduce flow over the ribs 62 between those channels 64 since they should be at similar pressures.

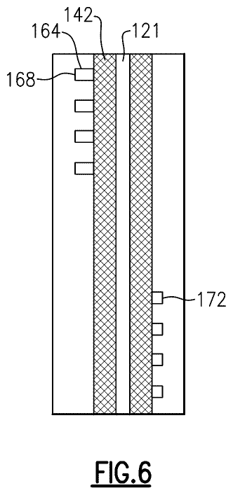

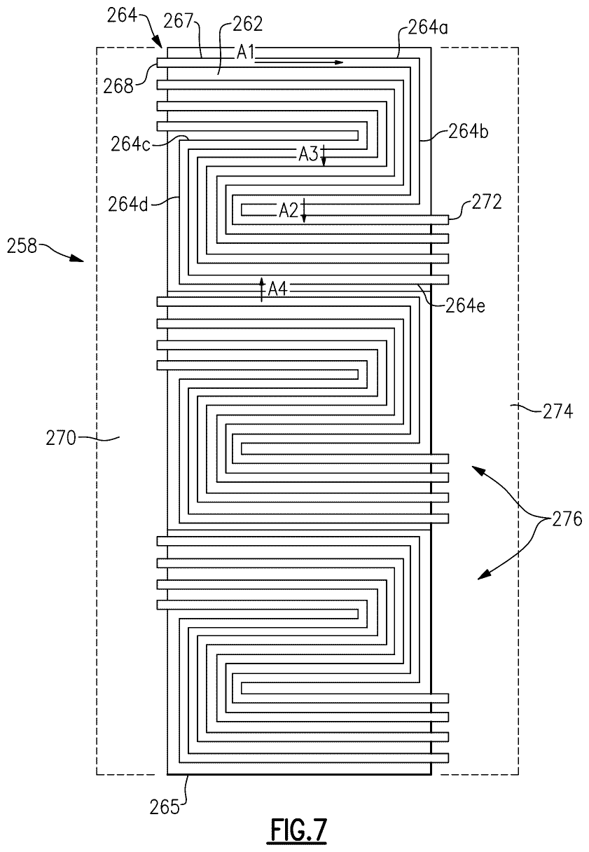

FIGS. 5-6 illustrate another embodiment of serpentine channels 164 for delivering the electrolyte 22 solution to the electrode 142. In this embodiment the serpentine channels 164 are arranged in a “nested” configuration such that the plurality of serpentine channels 164 “fit” one within another, side-by side, and each leg 164a, 164c, and 164e and turn section 164b and 164d of a first serpentine channel 164 follows the corresponding leg 164a, 164c, and 164e and turn section 164b and 164d of neighboring channels 164. Specifically, each of the inlet leg 164a, first turn section 164b, intermediate leg 164c, second turn section 164d, and outlet leg 164e of a first serpentine channel 164 are positioned adjacent to and aligned with the inlet leg 164a, first turn section 164b, intermediate leg 164c, second turn section 164d, and outlet leg 164e, respectively, of at least one neighboring serpentine channel 164. Only a single rib 162 separates the respective legs 164a, 164c, and 164e and respective turn sections 164b, 164d of neighboring channels 164. Again, the configuration of some channels 164 in the flow field 58 may be modified in order to tailor the pressure drop. For example, some channels 164 may be modified to have more or fewer legs 164a, 164c, 164e and turn sections 164b, 164d.

The difference in pressure between neighboring serpentine channels 164 in the nested configuration is less than the difference in pressure between neighboring channels 64 in the un-nested configuration. Consequently, the amount of electrolyte 22 flowing between corresponding legs 164a, 164c, 164e and turn sections 164b, 164d, respectively, of separate channels 164 (in the direction of arrow A3) is reduced in the nested configuration relative to the un-nested configuration shown in FIGS. 3-4. The ribs 162 and thus channels 164 may vary in width, depth, and/or length in order to further manage relative pressure drop between the channels 164. Furthermore, these dimensions of the ribs 162 and channels 164 in the nested configuration may vary from the dimensions of the ribs 62 and channels 64 in the un-nested configuration, shown in FIGS. 3-4.

FIG. 7 illustrates yet another example flow field 258 of serpentine channels 264 for delivering the electrolyte 22 solution to the respective electrode 242. The flow field 258 includes groups 276 of serpentine channels 264 in a nested configuration. Each of the channels 264 in a single group 276 are arranged in a nested configuration, as explained above for the embodiment shown in FIGS. 5-6. That is, each of the inlet leg 264a, first turn section 264b, intermediate leg 264c, second turn section 264d, and outlet leg 264e of one serpentine channel 264 are positioned adjacent to and aligned with the inlet leg 264a, first turn section 264b, intermediate leg 264c, second turn section 264d, and outlet leg 264e, respectively, of a neighboring serpentine channel 264 in the same group 276. Thus, the legs 264a, 264c, 264e and turn sections 264b, 264d of neighboring serpentine channels 264 in the same, first group 276 are positioned side-by-side, and separated by a single rib 262 respectively. As shown in FIG. 7, the groups 276 of serpentine channels 264 are in a repeated configuration such that the neighboring groups 276 are separated by a single rib 262. In this configuration, the outlet legs 264e of a first group 276 of serpentine channels 264 are positioned adjacent to the inlet legs 264a of a second, neighboring group 276 of serpentine channels 264. Further, the inlet legs 264a of the second, neighboring group 276 of serpentine channels 264 are positioned between the outlet legs 264e of the second, neighboring group 276 of serpentine channels 264 and the outlet legs 264e of the first group 276 of serpentine channels 264. These repeatable groups 276 of serpentine channels 264 enable a linear increase in flow capacity across the electrode 242 in order to scale the flow battery 20.

As shown in FIG. 7, the relative pressure drop between adjacent channels 264 causes a portion of the electrolyte 22 to flow over the ribs 262. For example, the pressure in the inlet leg 264a of one group 276 of serpentine channels 264 is higher than the pressure in the outlet leg 264e of the neighboring group 276 of serpentine channels 264, causing a portion of the electrolyte 22 to flow from the inlet leg 264a to the outlet leg 264e, as indicated by arrow A4 in FIG. 7.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A redox flow battery comprising:
at least one flow field including a plurality of serpentine channels to communicate electrolyte, each of the plurality of serpentine channels defining an inlet end, an outlet end, and a flow path fluidly connecting the inlet end with the outlet end, the plurality of serpentine channels arranged in a parallel flow configuration.

2. The redox flow battery of claim 1, wherein each of the plurality of serpentine channels comprises an inlet leg, a first turn section, an intermediate leg, a second turn section, and an outlet leg, the inlet leg extending from the inlet end to the first turn section, the intermediate leg extending from the first turn section to the second turn section, and the outlet leg extending from the second turn section to the outlet end.

3. The redox flow battery of claim 2, wherein the plurality of serpentine channels are arranged in an un-nested configuration.

4. The redox flow battery of claim 3, wherein the plurality of serpentine channels include a first serpentine channel and a second, neighboring serpentine channel, and the inlet leg of the first serpentine channel is adjacent to the outlet leg of the second, neighboring serpentine channel, and the outlet leg of the second, neighboring serpentine channel is between the inlet leg of the first serpentine channel and the inlet leg of the second, neighboring serpentine channel.

5. The redox flow battery of claim 2, wherein the plurality of serpentine channels are arranged in a nested configuration.

6. The redox flow battery of claim 5, wherein each of the plurality of serpentine channels is arranged side-by-side, such that the inlet leg, intermediate leg, outlet leg, first turn section, and second turn section of a first serpentine channel of the plurality of serpentine channels is arranged adjacent to and aligned with the inlet leg, intermediate leg, outlet leg, first turn section, and second turn section, respectively, of at least one neighboring serpentine channel of the plurality of serpentine channels.

7. The redox flow battery of claim 2, wherein each of the inlet leg, intermediate leg, outlet leg, first turn section, and second turn section are straight segments.

8. The redox flow battery of claim 1, further comprising a common inlet manifold and a common outlet manifold, and wherein each of the inlet ends opens to the common inlet manifold and each of the outlet ends opens to the common outlet manifold.

9. The redox flow battery of claim 1, further comprising:
a first liquid-porous electrode;
a second liquid-porous electrode spaced apart from the first liquid-porous electrode;
an ion-exchange membrane arranged between the first liquid-porous electrode and the second liquid-porous electrode;
the at least one flow field including first and second flow fields adjacent, respectively, the first liquid-porous electrode and second liquid-porous electrode; and
a first electrolyte storage vessel connected in a first circulation loop with the first flow field and a second electrolyte storage vessel connected in a second circulation loop with the second flow field.

10. A redox flow battery comprising:
at least one flow field including a plurality of serpentine channels to communicate electrolyte, each of the serpentine channels defining an inlet end, an outlet end, and a flow path fluidly connecting the inlet end with the outlet end, the serpentine channels are arranged in a parallel flow configuration, the plurality of serpentine channels arranged in an un-nested configuration.

11. The redox flow battery of claim 10, further comprising:
a first circulation loop;
a second circulation loop;
a first electrolyte storage vessel connected to the first circulation loop;
a second electrolyte storage vessel connected to the second circulation loop; and
the at least one flow field includes a first flow field and a second flow field, the first and second circulation loops operable to fluidly communicate with the first and second flow fields, respectively, and first and second electrolyte storage vessels, respectively, and an ion-exchange membrane is arranged between the first and the second flow fields.

12. The redox flow battery of claim 10, wherein each of the plurality of serpentine channel comprises an inlet leg, a first turn section, an intermediate leg, a second turn section, and an outlet leg, the inlet leg extending from the inlet end to the first turn section, the intermediate leg extending from the first turn section to the second turn section, and the outlet leg extending from the second turn section to the outlet end.

13. The redox flow battery of claim 12, wherein the plurality of serpentine channels includes a first serpentine channel and a second, neighboring serpentine channel and the inlet leg of the first serpentine channel is adjacent to the outlet leg of the second, neighboring serpentine channel, and the outlet leg of the second, neighboring serpentine channel is between the inlet leg of the first serpentine channel and the inlet leg of the second, neighboring serpentine channel.

14. The redox flow battery of claim 13, wherein each of the inlet leg, intermediate leg, outlet leg, first turn section, and second turn section are straight segments.

15. A redox flow battery comprising:
at least one flow field including at least one group of serpentine channels to communicate electrolyte, each of the serpentine channels defining an inlet end, an outlet end, and a flow path fluidly connecting the inlet end with the outlet end, and the serpentine channels are arranged in a parallel flow configuration and in a nested configuration.

16. The redox flow battery of claim 15, wherein each serpentine channel comprises an inlet leg, a first turn section, an intermediate leg, a second turn section, and an outlet leg, the inlet leg extending from the inlet end to the first turn section, the intermediate leg extending from the first turn section to the second turn section, and the outlet leg extending from the second turn section to the outlet end.

17. The redox flow battery of claim 16, wherein the at least one group of serpentine channels includes a first group of serpentine channels and each serpentine channel of the first group of serpentine channels is arranged side-by-side, such that the inlet leg, intermediate leg, outlet leg, first turn section, and second turn section of a first serpentine channel of the first group of serpentine channels is arranged adjacent to and aligned with the inlet leg, intermediate leg, outlet leg, first turn section, and second turn section, respectively, of at least one neighboring serpentine channel in the first group of serpentine channels.

18. The redox flow battery of claim 17, wherein the at least one group of serpentine channels includes a second group of serpentine channels that neighbors the first group of serpentine channels, and the first group of serpentine channels and the second group of serpentine channels are arranged in a repeated, configuration such that the outlet legs of the first group of serpentine channels are positioned adjacent to the inlet legs of the second group of serpentine channels and the inlet legs of the second group of serpentine channels are positioned between the outlet legs of the second group of serpentine channels and the outlet legs of the first group of serpentine channels.

19. The redox flow battery of claim 16, wherein each of the inlet leg, intermediate leg, outlet leg, first turn section, and second turn section are straight segments.

20. The redox flow battery of claim 15, further comprising:
a first circulation loop;
a second circulation loop;
a first electrolyte storage vessel connected to the first circulation loop;
a second electrolyte storage vessel connected to the second circulation loop; and
the at least one flow field includes a first flow field and a second flow field, the first and second circulation loops operable to fluidly communicate with the first and second flow fields, respectively, and the first and second electrolyte storage vessels, respectively, and an ion-exchange membrane is arranged between the first and the second flow fields.
